(19) United States
(12) Patent Application Publication
(10) Pub. No.: US 2019/0378269 A1
(43) Pub. Date: Dec. 12, 2019

(54) SYSTEM AND METHOD FOR MONITORING A CAMERA WASH CYCLE

(71) Applicant: GM GLOBAL TECHNOLOGY OPERATIONS LLC, Detroit, MI (US)

(72) Inventor: Sai Vishnu Aluru, Novi, MI (US)

(21) Appl. No.: 16/002,361

(22) Filed: Jun. 7, 2018

(51) Int. Cl. G06T 7/00; G06T 7/13

(52) U.S. Cl. CPC G06T 7/0008; G06T 7/13; B60S 3/04; G06T 2207/30252; G06T 7/001

(57) ABSTRACT

A method of monitoring a camera wash cycle includes capturing a series of images through a camera, processing each of the series of images, reviewing each of the series of images for changes in an image attribute indicating an occurrence of the camera wash cycle, and signaling the occurrence of the camera wash cycle.

### INTRODUCTION

The subject disclosure relates to the art of monitoring systems and, more particularly, to a system for monitoring a camera wash cycle on a vehicle production line.

Vehicle manufacturing involves the use of assembly lines. A vehicle travels along the assembly line and undergoes various component installation, testing, and other processes. It is desirable to automatically monitor many of the installation, testing, and other processes to ensure conformance to various standards, consistency, and quality. Many modern vehicles are provided with cameras. The cameras undergo a wash process during production. Currently, wash monitoring is done manually. It would be desirable to provide a system that monitors for the occurrence of a wash cycle. It would also be desirable to automatically monitor wash cycle quality and/or consistency.

### SUMMARY

In one exemplary embodiment, a method of monitoring a camera wash cycle includes capturing a series of images through a camera, processing each of the series of images, reviewing each of the series of images for changes in an image attribute indicating an occurrence of the camera wash cycle, and signaling the occurrence of the camera wash cycle.

In addition to one or more of the features described herein, exemplary embodiments may include wherein processing each of the series of images includes converting each of the series of images to grayscale images.

In addition to one or more of the features described herein, exemplary embodiments may include identifying edges in the grayscale images.

In addition to one or more of the features described herein, exemplary embodiments may include wherein reviewing each of the series of images includes counting a number of pixels in each of the series of images.

In addition to one or more of the features described herein, exemplary embodiments may include detecting a change in the number of pixels from one of the series of images to another of the series of images, wherein the change in the number of pixels indicting the occurrence of the camera wash cycle.

In addition to one or more of the features described herein, exemplary embodiments may include detecting a duration of the change in the number of pixels from one of the series of images to others of the series of images, wherein the duration of the change indicates a duration of the camera wash cycle.

In addition to one or more of the features described herein, exemplary embodiments may include identifying a quality of the camera wash cycle based on changes in the image attribute.

Also disclosed is a system for monitoring a camera wash cycle including a processor, and a non-volatile memory operably connected to the processor. The non-volatile memory having stored thereon a set of instructions which, when executed by the processor, causes the processor to capture a series of images through a camera, process each of the series of images, review each of the series of images for changes in an image attribute indicating an occurrence of the camera wash cycle, and signal the occurrence of the camera wash cycle.

In addition to one or more of the features described herein, exemplary embodiments may include wherein the set of instructions, when executed by the processor, causes the processor to convert each of the series of images to grayscale images when processing the series of images.

In addition to one or more of the features described herein, exemplary embodiments may include wherein the set of instructions, when executed by the processor, causes the processor to identify edges in the grayscale images.

In addition to one or more of the features described herein, exemplary embodiments may include wherein the set of instructions, when executed by the processor, causes the processor to count a number of pixels in each of the series of images when reviewing each of the series of images.

In addition to one or more of the features described herein, exemplary embodiments may include wherein the set of instructions, when executed by the processor, causes the processor to detect a change in the number of pixels from one of the series of images to another of the series of images, wherein the change in the number of pixels indicates the occurrence of the camera wash cycle.

In addition to one or more of the features described herein, exemplary embodiments may include wherein the set of instructions, when executed by the processor, causes the processor to detect a duration of the change in the number of pixels from one of the series of images to others of the series of images, wherein the duration of the change indicates a duration of the camera wash cycle.

In addition to one or more of the features described herein, exemplary embodiments may include wherein the set of instructions, when executed by the processor, causes the processor to identify a quality of the camera wash cycle based on changes in the image attribute.

Further discloses is a system for monitoring a camera wash cycle including a memory unit for receiving a series of images from a camera, an image processor operable to process each of the series of images from the camera, an image analyzer operable to review each of the series of images for changes in one or more selected image attributes, and a wash cycle analyzer operable to detect an occurrence of the camera wash cycle based on changes in the one or more selected image attributes.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 depicts a vehicle manufacturing facility including a camera wash cycle monitoring system, in accordance with an aspect of an exemplary embodiment;

FIG. 2 depicts a block diagram of a camera wash monitoring system, in accordance with an aspect of an exemplary embodiment;

FIG. 3 depicts a flow diagram illustrating a method of monitoring a camera wash cycle, in accordance with an aspect of an exemplary embodiment; and

FIG. 4 is a graph depicting a change in image attributes indicating an occurrence of a camera wash cycle, in accordance with an aspect of an exemplary embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

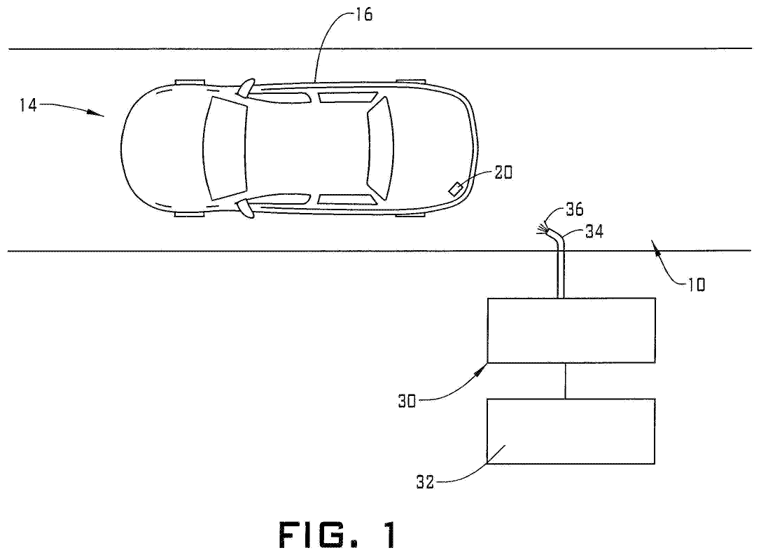

A vehicle assembly line, in accordance with an aspect of an exemplary embodiment, is indicated at 10 in FIG. 1. A vehicle 14 having a body 16 is movable along vehicle assembly line 10. Vehicle 14 includes a camera 20 that may be mounted in body 16. It should be understood that the number, position, and type of camera may vary. During manufacture, it may be desirable to clean camera 20. As such, vehicle 14 is passed through a camera wash system 30 arranged along vehicle assembly line 10. Camera wash system 30 includes a controller 32 operatively connected to a washing element 34 that is selectively controlled to deliver a washing fluid 36 onto camera 20.

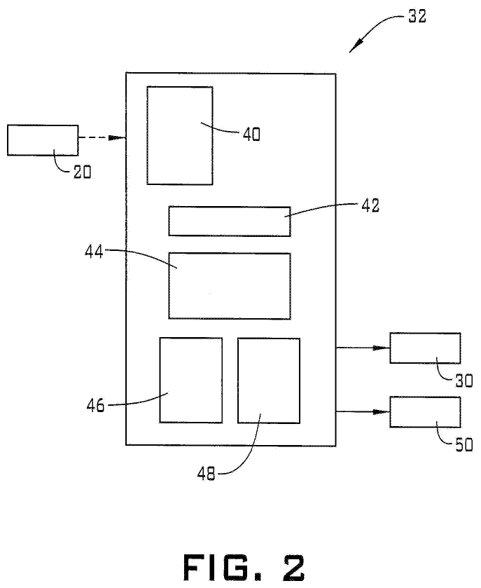

In accordance with an exemplary aspect illustrated in FIG. 2, controller 32 includes a central processor unit (CPU) or general processor unit (GPU) 40 operatively connected to a non-volatile memory module 42. Controller 32 also includes an image processor 44, an image analyzer 46 and a camera wash cycle analyzer 48 operatively connected to processor 40. Controller 32 may also be connected to camera 20. A connection with camera 20 may be a wired, or a wireless connection. In either case, images captured by camera 20 may be passed to controller 32. As will be detailed herein, controller 32 evaluates images captured by camera 20 to determine an occurrence of, a duration of, and/or a quality of, a camera wash cycle performed by camera wash system 30. Controller 32 may then deliver an output 50 pertaining to qualities, e.g., occurrence, efficacy, and the like of the camera wash cycle.

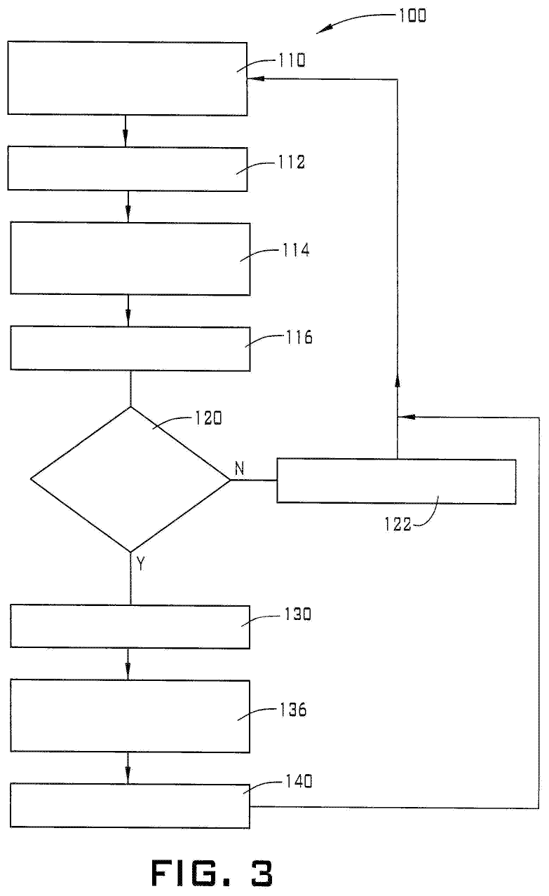

Reference will now follow to FIG. 3 in describing a method 100 for monitoring details of a camera wash cycle in accordance with an exemplary aspect. In block 110, a series of images are captured by camera 20 as vehicle 14 moves along vehicle assembly line 10 past camera washing system 30. The series of images are stored in non-volatile memory 42 and accessed by image processor 44. Image processor 44 may process each of the series of images in block 112. For example, image processor 44 may convert each of the series of images into grayscale images.

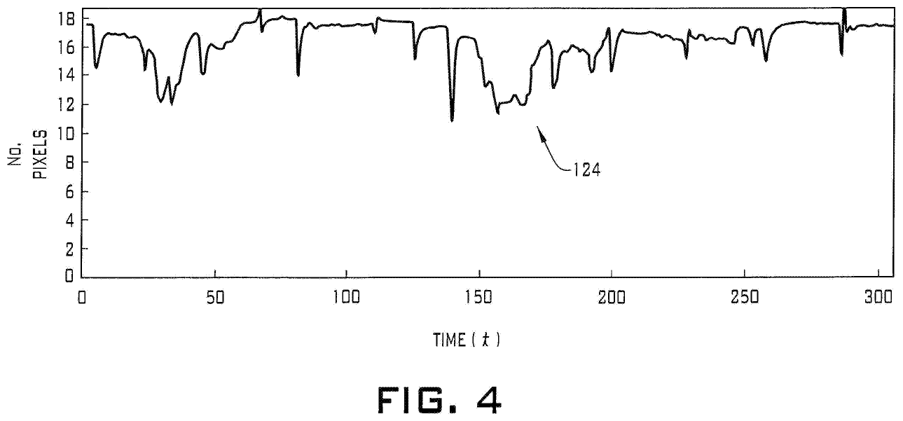

In block 114, image analyzer 46 may identify image attributes, such as edges, in each of the series of grayscale images. Image analyzer 46 may also count or determine a number of pixels that form each of the image attributes or edges, in block 116. In block 120, wash cycle analyzer 48 looks for a change in the image attributes. If no change is detected, no wash is indicated in block 122 and monitoring continues. A change in image attributes could, for example, include camera wash cycle analyzer 48 determining that a reduction in the number of pixels that form the edges has occurred in one or more of the series of images. For example, if a zone, defined by a reduction in image attributes of a selected amount over a selected period of time, such as shown at 124 in FIG. 4 occurs, controller 32 determines that a camera wash cycle has happened, in block 130. The occurrence of the camera wash cycle may then be signaled to personnel.

In block 136, camera wash cycle analyzer 48 may look at a duration of the camera wash cycle. In this manner, camera wash cycle analyzer 48 may also determine a length of and/or a quality of the wash cycle in block 140. For example, wash cycle analyzer, in addition to determining that a camera wash cycle has occurred, may determine that the camera wash cycle was active for a selected period and may determine whether washing element 34 or additional washing elements (not shown) functioned properly.

The terms “about” and “substantially” are intended to include the degree of error associated with measurement of the particular quantity based upon the equipment available at the time of filing the application. For example, “about” and “substantially” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of monitoring a camera wash cycle comprising:
capturing a series of images through a camera;
processing each of the series of images;
reviewing each of the series of images for changes in an image attribute indicating an occurrence of the camera wash cycle; and
signaling the occurrence of the camera wash cycle.

2. The method of claim 1, wherein processing each of the series of images includes converting each of the series of images to grayscale images.

3. The method of claim 2, further comprising identifying edges in the grayscale images.

4. The method of claim 1, wherein reviewing each of the series of images includes counting a number of pixels in each of the series of images.

5. The method of claim 4, further comprising detecting a change in the number of pixels from one of the series of images to another of the series of images, wherein the change in the number of pixels indicates the occurrence of the camera wash cycle.

6. The method of claim 4, further comprising detecting a duration of the change in the number of pixels from one of the series of images to others of the series of images, wherein the duration of the change indicates a duration of the camera wash cycle.

7. The method of claim 1, further comprising identifying a quality of the camera wash cycle based on changes in the image attribute.

8. A system for monitoring a camera wash cycle in a vehicle during vehicle assembly comprising:
a processor; and
a non-volatile memory operably connected to the processor, the non-volatile memory having stored thereon a set of instructions which, when executed by the processor, causes the processor to:
capture a series of images through a camera;
process each of the series of images;
review each of the series of images for changes in an image attribute indicating an occurrence of the camera wash cycle; and
signaling the occurrence of the camera wash cycle.

9. The system according to claim 8, wherein the set of instructions, when executed by the processor, causes the processor to convert each of the series of images to grayscale images when processing the series of images.

10. The system according to claim 9, wherein the set of instructions, when executed by the processor, causes the processor to identify edges in the grayscale images.

11. The system according to claim 8, wherein the set of instructions, when executed by the processor, causes the processor to count a number of pixels in each of the series of images when reviewing each of the series of images.

12. The system according to claim 11, wherein the set of instructions, when executed by the processor, causes the processor to detect a change in the number of pixels from one of the series of images to another of the series of images, wherein the change in the number of pixels indicates the occurrence of the camera wash cycle.

13. The system according to claim 11, wherein the set of instructions, when executed by the processor, causes the processor to detect a duration of the change in the number of pixels from one of the series of images to others of the series of images, wherein the duration of the change indicates a duration of the camera wash cycle.

14. The system according to claim 11, wherein the set of instructions, when executed by the processor, causes the processor to identify a quality of the camera wash cycle based on changes in the image attribute.

15. A system for monitoring a camera wash cycle comprising:
a memory unit for receiving a series of images from a camera;
an image processor operable to process each of the series of images from the camera;
an image analyzer operable to review each of the series of images for changes in one or more selected image attributes; and
a wash cycle analyzer operable to detect an occurrence of the camera wash cycle based on changes in the one or more selected image attributes.
